(19) United States
(12) Patent Application Publication
(10) Pub. No.: US 2009/0004624 A1
(43) Pub. Date: Jan. 1, 2009

(54) Piezo Insert and Piezo Packer for Operating an Implant Surgical Operation Using Piezoelectric Device

(76) Inventor: Hong-Chan Lee, Seoul (KR)

Correspondence Address: HARNESS, DICKEY, & PIERCE, P.L.C, 7700 Bonhomme, Suite 400, ST. LOUIS, MO, 63105, US

(21) Appl. No.: 11/953,533

(22) Filed: Dec. 10, 2007

(30) Foreign Application Priority Data
Jun. 28, 2007 (KR) 10-2007-0064322

(51) Int. Cl. A61C 3/02

(52) U.S. Cl. 433/144

(57) ABSTRACT

The invention concerns a piezo insert and a piezo packer for implant surgical operation with a piezoelectric device. The piezo insert according to the invention consists of a piezo insert body one end of which is inserted in and fixed to a hand piece of the piezoelectric main device; an insert pole extending from the other end of the piezo insert body; and an insert tip formed at the end of the insert pole. The piezo packer consists of a piezo packer body one end of which is inserted in and fixed to a hand piece of a piezoelectric main device; a packer pole extending from the other end of the piezo packer body and a packer tip formed at the end of the packer pole. With the piezo insert and the piezo packer according to the invention, forming and expanding a hole in a vertical direction in a residual ridge at a portion for implant placement is facilitated when applying bone grafting in a maxillary sinus, and damages can be avoided in a maxillary sinus membrane, in order to effectively insert graft materials through the formed hole in the residual ridge for bone grafting.

### BACKGROUND OF THE INVENTION

1. Technical Field

The invention relates to a piezoelectric device used for bone grafting in implant surgical operation for dental treatment, and more particularly to a piezo insert and a piezo packer designed suitably for grafting a maxillary bone with a piezoelectric device.

2. Description of the Prior Art

Implant surgical operation is generally considered as an important part in the dental field, and concepts and technologies associated with the implant surgical operation have been developing continuously. An easy case for the implant surgical operation can generally be done by a dentist who doesn't have much experience. Some cases, however, still present problems that must be solved, one of them being represented by the implant surgical operation associated with a maxillary sinus. Because there is not a sufficient residual ridge in a vertical direction in implant surgical operation of a maxillary posterior tooth, grafting is required in the maxillary sinus in many cases. Grafting in a maxillary sinus is applied in common nowadays and categorized as two types. One of them is grafting with an osteotome and the other is to form a lateral window on the lower part of a cheekbone, and then to directly lift a maxillary sinus membrane to pack a graft material between the interior border of a maxillary sinus and the maxillary sinus membrane.

If the height of a residual ridge is remarkably low in the implant operation, even wider flap design and operation by lateral access should be applied. When forming a window, however, it is very hard to access the maxillary sinus because, of high probability of rupture of sinus membrane, presence of septum, very technique-sensitive procedure during lifting, exsistence of artery. There also exists increased opportunistic infection because of a wide surgical field, and a patient feels very uncomfortable during and after the operation. Forming a window leads to intentionally removing a lateral part of a maxillary bone and thus to blocking blood flow, so that a useful nutritional base essential for the process of self-ossification of a grafted bone is reduced to result in a long healing period and ossification time. Many frontiers have attempted to overcome the aforementioned disadvantages and problems in many ways.

Bucci Sabattini reported that, when maxillary sinus grafting was required for implant placement in a maxillary posterior tooth, it was possible to relax the maxillary sinus membrane and fill the sinus with a grafting material by injecting an injectable graft material in the maxillary sinus (See, Bucci Sabattini, Salvatorelli. New simplified technique for major augmentation of the maxillary sinus. 35th Annual Meeting of the Continental European Division of the International Association for Dental Research, 1999). This is an exemplary type using hydraulic pressure.

Leon Chen reported, in his paper (see, Leon Chen, Jennifer Cha. An 8-Year Retrospective Study: 1100 Patients Receiving 1557 Implants Using the Minimally Invasive Hydraulic Sinus Condensing Technique. J Periodontol 2005;76:482-491), that he did grafting in a maxillary sinus while the maxillary sinus membrane was exposed after grinding away the maxillary interior border of the maxillary sinus with a high-speed hand piece in fixation of 1557 implants in about 1100 cases that resulted in a very high ratio of success. Chen named this operation Hydraulic Sinus Condensing. This operation is a method of approaching an alveolar ridge as in the osteotome technique, but is considered as a totally new attempt. However, some dentists found out some disadvantages in the method by Leon Chen, and expressed different views. The most disadvantageous thing is that it is a very sensitive process and it is almost impossible to exclude contamination by cooling water that is essentially used with a high-speed hand piece. In particular, there is a possibility that the contamination of a graft material may be involved with the grafted bone in the maxillary sinus and may also cause delayed infection after the operation. In some cases, emphysema may be caused and it may be hard to avoid bone heating depending on a position of a water-spray opening of the hand piece head when the residual ridge is longer than 6 to 7 mm.

In late 1990s, Torrella reported a clinically convenient method of maxillary sinus operation for approaching a lateral side with an ultrasonic device, as compared to prior art methods (see, Vercellotti T, De Paoli S, Nevins M., The piezoelectric bony window osteotomy and sinus floor elevation: Introduction of a new technique for simplification of the sinus augmentation procedure. Int J Periodontics Restorative Dent 2001;21:561-567). Vercellotti proposed a more convenient method of maxillary bone grafting with a piezoelectric device more improved, and reported it was clinically easy to apply the method as compared to the prior art rotary device (see, Torrella F, Pitarch J, Cabanes G, Anita E. Ultrasonic osteotomy for the surgical approach of the maxillary sinus: A technical note. Int J Oral Maxillofac Implants 1998;13;697-700). In 2003, Korean professor Dong Seok Sohn introduced the case of bone grafting in a maxillary sinus with a piezoelectric device in Korea (see Dental Clinic, 2002). Sohn reported in the Dental Clinic Journal that the piezoelectric device was advantageous for protecting a sensitive maxillary sinus membrane in forming a window and then lifting the membrane because there is a quite low possibility of boring or bursting even when the piezoelectric device touches soft tissues, namely the maxillary sinus membrane. In the journal, Sohn obtained a relatively good result as compared to the result by prior methods, satisfactory to both of operators and patients by attempting a method of approaching the membrane from the position for implant placement, differently from prior art methods in approaching the membrane, while operating maxillary bone grafting in a maxillary sinus with the piezoelectric device.

When using the piezoelectric device, a conventional piezo insert is used without modification. The conventional piezo insert, however, was not designed for crestally approached maxillary bone grafting, so that there arise many problems, e.g., inefficient cutting force, long time in the cutting process in turn, fractures of inserts resulting from continuing vibration in the osteotomy site typical characteristics of piezoelectricity. Because of low cutting-efficiency surgeon is apt to apply excessive force to grind out the last maxillary alveolar bone under the sinus. The surgeon has no chance to feel the light drop of the device into the sinus cavity at the moment when the device approaches the maxillary sinus, the force thus causing perforating on the maxillary sinus membrane, etc.

### BRIEF SUMMARY OF THE INVENTION

It is an object of the invention, in maxillary bone grafting with a piezoelectric device, to provide a piezo insert and a piezo packer, with which it is easy to form and expand a vertical hole in a residual ridge at a position for implant placement, possible to avoid damages on a maxillary sinus membrane and effectively to insert a graft material through the hole formed in the residual ridge in order to perform bone grafting.

An aspect of the invention to achieve the aforementioned technical subject concerns a piezo insert for implant surgical operation with a piezoelectric device. The piezo insert in the invention is characterized in that it comprises a piezo insert body one end of which is inserted in and fixed to a hand piece of a piezoelectric main device; an insert pole extending from the other end of the piezo insert body; and an insert tip formed at the end of the insert pole, the insert tip being provided with a plurality of holes or notches at its end in order to enhance a vertical cutting force.

In one aspect of the invention, the insert tip further comprises a plurality of holes formed at its end and on its lateral side to achieve both of vertical cutting force and lateral cutting force.

In another aspect of the invention, the insert pole has either a linear structure or a structure bent at least once.

In still another aspect of the invention, the invention concerns a piezo packer for implant surgical operation with a piezoelectric device. The piezo packer in the invention is characterized in that it comprises a piezo packer body one end of which is inserted in and fixed to a hand piece of a piezoelectric main device; a packer pole extending from the other end of the piezo packer body; and a packer tip formed at the end of the packer pole, the packer tip having a plurality of projections at its end in order to enhance bone removal and vibration transfer efficiency transferred to a graft material.

In one aspect of the invention, the insert pole has either a linear structure or a structure bent at least once. In the following, brief description of the drawings will be provided to aid full understanding of the drawings used in the following for detailed description of the invention.

### BRIEF DESCRIPTION OF THE DRAWINGS

The features and advantages of the present invention will become apparent from the following detailed description of a preferred embodiment thereof illustrated with reference to the accompanying drawings, wherein:

FIG. 1 shows schematically how a piezo insert and a piezo packer according to the invention are connected to and used in a piezoelectric main device;

FIG. 2 is a perspective view of a piezo insert and a partially expanded view of an insert tip according to one preferred embodiment of the invention;

FIG. 3 is a perspective view of a piezo packer and a partially expanded view of a packer tip according to one preferred embodiment of the invention;

FIG. 4 shows a piezo packer of a linear structure;

FIG. 5 shows a cross section of a maxillary sinus for bone grafting in order to fix an implant;

FIGS. 6a to 6j show a sequential flow of a process of forming a hole in a residual ridge of a maxillary sinus and of bone grafting with a piezo insert and a piezo packer according to the invention; and

FIGS. 7a and 7b show X ray photography for the area around a maxillary sinus before/after fixing an implant.

### DETAILED DESCRIPTION OF THE PREFERRED EMBODIMENT

Hereinafter, the invention will be described in more detail with reference to embodiments and the drawings of the invention.

It should be noted that the exemplary accompanying drawings and the details therein illustrating preferred embodiments of the invention should be referenced in order to fully understand the advantages in operation of the invention and the object achieved by those embodiments of the invention.

It should also be noted that the embodiments of the invention can be modified in a variety of forms, and the scope of the invention should not be construed to be limited to the embodiments to be described in the following. It should also be noted that the embodiments of the invention are only intended to provide more thorough description of the invention to those skilled in the art. Therefore, some features of the elements in the drawings may be exaggerated in dimensions to emphasize even clearer description of the invention. In understanding the drawings, it should be noted that the same components are denoted by the same numerals as possible throughout the drawings. Detailed statement for known functions and configurations will be omitted when it is decided that they would unnecessarily make the subject of the invention unclear.

Hereafter, with reference to the accompanying drawings, the piezo insert and the piezo packer for implant surgical operation with a piezoelectric device of the invention will be described in detail, by describing the preferred embodiments of the invention.

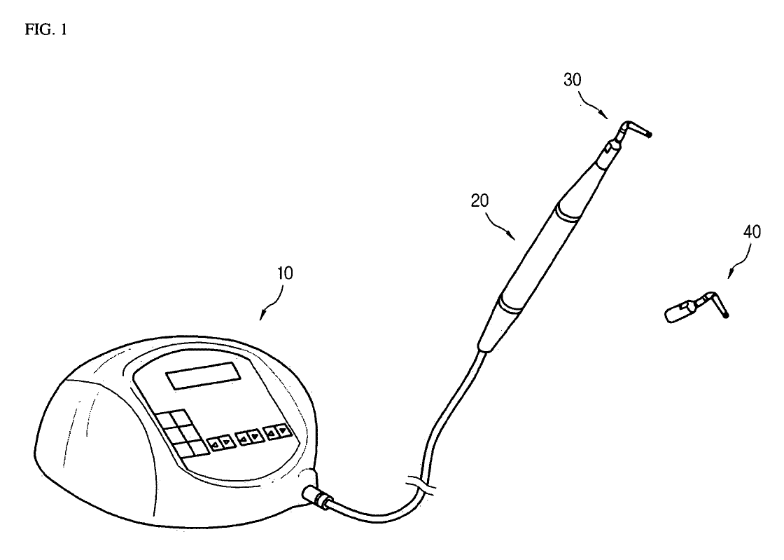

FIG. 1 shows a state that the piezo insert and the piezo packer of the invention are connected to and used in a piezoelectric main device.

With reference to FIG. 1, the piezo insert 30 and the piezo packer 40 of the invention are equipped to the hand piece 20 of the piezoelectric main device 10, wherein electric vibration generated in the piezoelectric main device 10 is transferred to the insert 30 and the packer 40 which in turn mechanically vibrate. The piezo insert 30 is used for forming a vertical hole in a residual ridge in a maxillary sinus or expanding an already formed hole therein. The piezo packer 40 is used effectively to push and put a graft material to a portion below a maxillary sinus membrane through the formed hole.

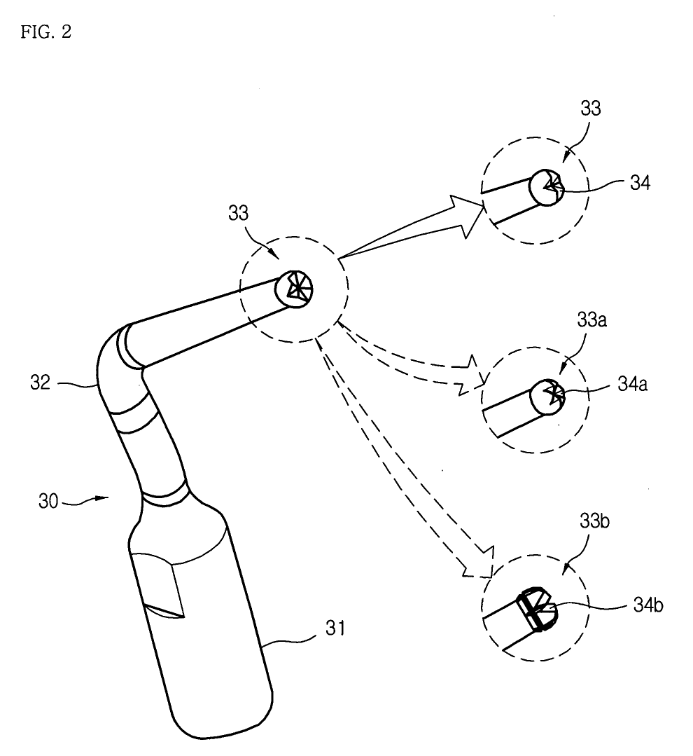

FIG. 2 is a perspective view of a piezo insert and a partially expanded view of an insert tip according to a preferred embodiment of the invention.

With reference to FIG. 2, the piezo insert 30 consists of a piezo insert body 31 one end of which is inserted in the hand piece 20, an insert pole 32 extending from the other end of the body 31 and an insert tip 33 formed at an end of the insert pole 32. The insert pole 32 is shaped bent to allow easy access to a maxillary sinus, e.g., bent like L. In particular, the insert tip 33 has a plurality of holes 34 at its end in order to enhance vertical cutting force, and preferably is generally shaped a disk rather than a perfect sphere. This is the case to avoid the insert tip 33 to excessively push a maxillary sinus membrane and thus cause the membrane to be torn, while the insert tip 33 enters the maxillary sinus with a jerk at the moment when the insert 30 grinds away the last part of the residual ridge.

A conventional piezo insert was designed properly to form a window on a lateral side of a maxillary bone. Accordingly, forming a vertical hole in a residual ridge with the conventional piezo insert takes a lot of time and causes various problems in addition as described.

To address such problems, the inventor designed a novel piezo insert 30 of the invention to be suitable for forming a hole vertically in a residual ridge at a portion for insert fixation.

The insert tip 33 has a plurality of cross-shaped holes 34 formed at its end, wherein the structure of the tip 33 may be modified various in its shape. For example, an insert tip 33a may be provided which has 6 or more holes 34a in a radial structure in order to enhance vertical cutting force. Another type of an insert tip 33b may be provided which has a plurality of holes 34b formed at its end and on its lateral side to provide both of vertical cutting force and lateral cutting force. The diameter of the insert tip 33 may be various, e.g., 1.6 mm, 1.8 mm, 2.2 mm, 3.0 mm, etc. In operation, a proper insert tip size is selected depending on the thickness of a residual ridge to form a hole and a larger size is used gradually to expand the formed hole.

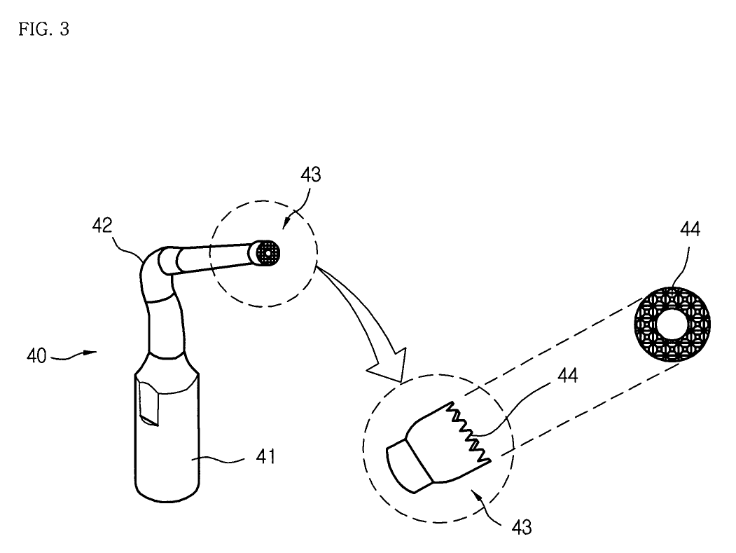

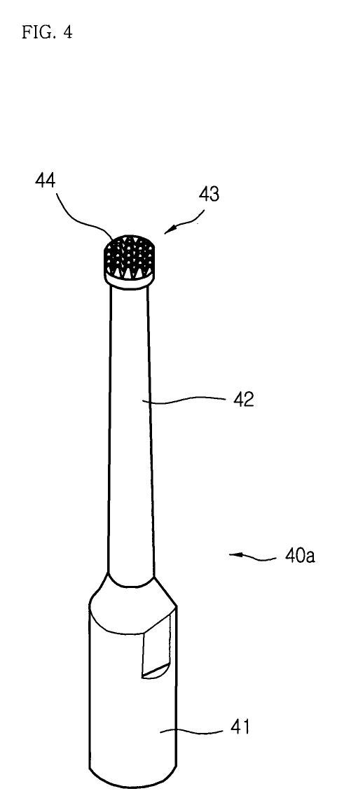

FIG. 3 is a perspective view of a piezo packer and a partially expanded view of a packer tip according to a preferred embodiment of the invention. FIG. 4 illustrates a different type of a piezo packer.

Referring to FIG. 3, the piezo packer 40 consists of a piezo packer body 41 one end of which is inserted in and fixed to the hand piece 20, a packer pole 42 extending from the other end of the body 41 and a packer tip 43 formed at the end of the packer pole 42. The packer pole 42 is bent like, e.g., ‘L’ in its shape to allow easy access to a maxillary sinus. In particular, the end of the packer tip 43 has a plurality of projections 44 in one uniform plane. The plurality of projections 44 is used to remove a bone and enlarge the contact area with a graft material thus to enhance a vibration transfer efficiency and thus for the graft material to be inserted even more easily, while the graft material is pushed below the maxillary sinus membrane through the hole.

When the graft material is blocked in the narrow hole while the graft material is pushed in the maxillary sinus through the hole, the piezo packer 40 is put on the graft material then to operate it while slowly progressing it. The piezo packer 40 then enters the sinus smoothly without excessive impact on the maxillary sinus membrane. Also, when the graft material is rammed only upwards too much, the vibration from the piezoelectric main device 10 is transferred to each particle of the graft material, so that the material well spreads both upwards and laterally and relaxation is also easily achieved with the piezoelectric main device 10 that is characterized by vibration several tens of thousands of times per unit time. That is, since the graft material is rammed together with vibration, the bone grafting process is performed and can be finished even more easily and safely.

The diameter of the packer tip 43 is varied in size as for the insert tip 33. The packer pole 42 can be shaped as illustrated in FIG. 4 to be a piezo packer 40a having a linear structure. The insert pole 32 may also have a linear structure. The insert pole 32 and the packer pole 42 may be shaped in various ways and have either a bent structure or a linear structure depending on a portion for implant placement.

Hereinafter, the bone grafting sequence will be described with reference to the drawings, in which a piezo insert and a piezo packer are used for implant surgical operation with the piezoelectric device according to the invention.

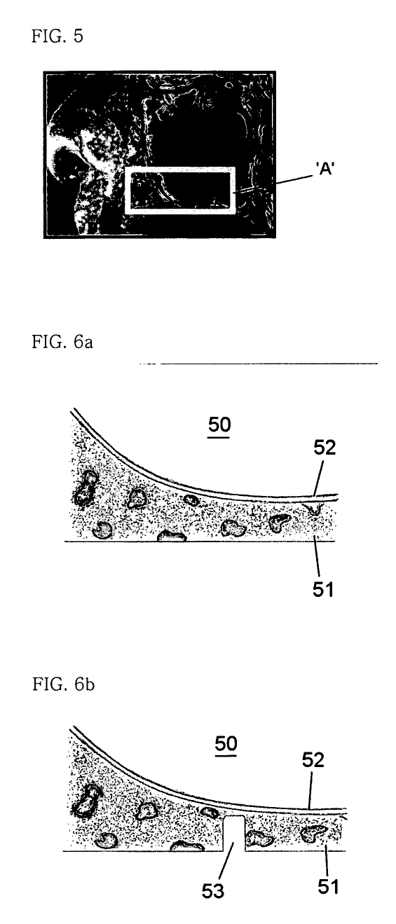

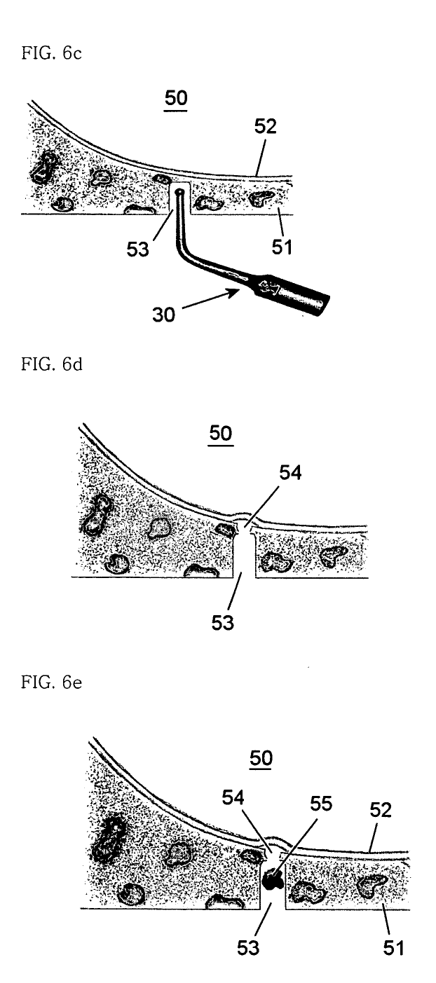

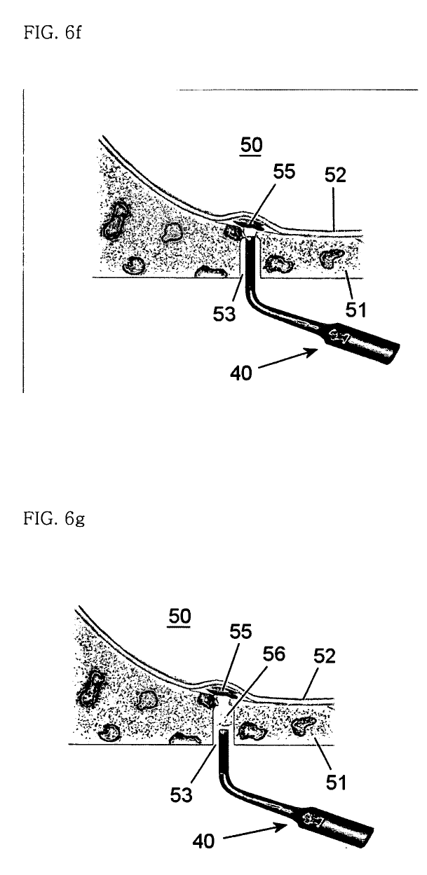

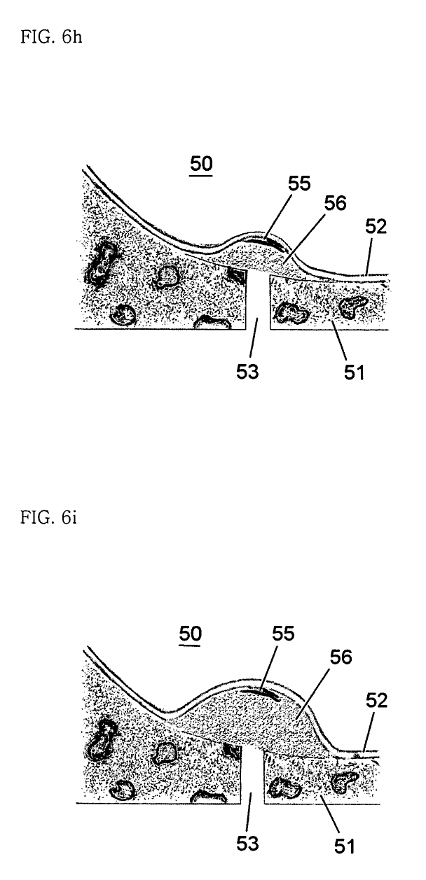

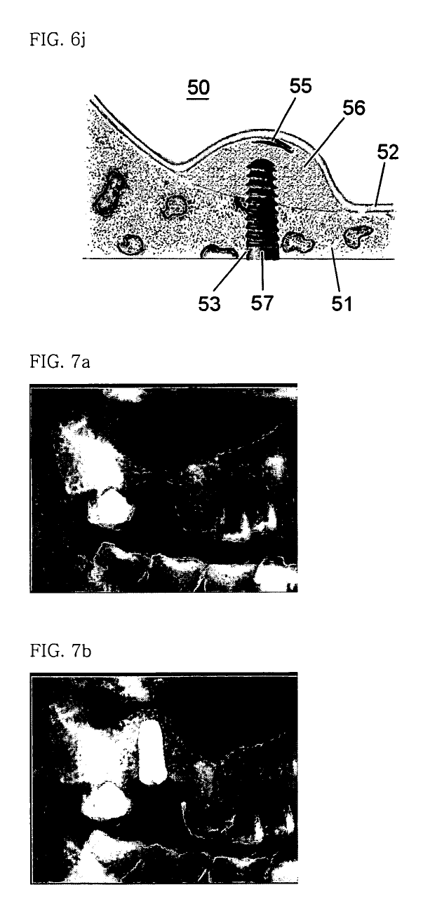

FIG. 5 illustrates a cross section of a maxillary sinus for bone grafting in order to apply implant placement. FIGS. 6a to 6j are a sequential process of forming a hole in a residual ridge of a maxillary sinus and of bone grafting with the piezo insert and the piezo packer according to the invention.

In FIG. 5, the area denoted by ‘A’ is a portion in a maxillary sinus for implant placement. Now described will be the process of forming a hole in a residual ridge and applying bone grafting with the piezo insert 30 and the piezo packer 40 according to the invention, for the portion A in the maxillary sinus.

FIG. 6a shows a state that a molar tooth is gone and only a maxillary alveolar bone is left as a residual ridge 51. Here, the reference numeral 52 denotes a maxillary sinus membrane. In this state, it is impossible to apply implant placement directly to the residual ridge 51. Therefore, it is required to apply bone grafting to a relevant portion to make the residual ridge 51 thicker. As shown in FIG. 6b, a hole 53 is formed in the residual ridge 51. In the process of forming the hole 53, the hole 53 may be formed with an operation drill by leaving a thickness of approximately 1 to 2 mm between the end of the hole and the maxillary sinus membrane 52, if the residual ridge 51 is relatively thick. If the residual ridge 51 is quite thin, e.g., 4 to 5 mm or less, a hole 53 is formed with the piezo insert 30 from the beginning to expose an opening 54 below the maxillary sinus membrane 52, as shown in FIG. 6c.

FIG. 6d illustrates a hole 53 formed in the residual ridge 51 extending to the opening 54 without tearing the maxillary sinus membrane 52. When grinding the residual ridge 51 in the interior border of the maxillary sinus 50 to expose only the maxillary sinus membrane 52, it is seen that the piezo insert 30 according to the invention is outstandingly good over a conventional piezo insert, by means of the aforementioned characteristics thereof. In particular, in this operation process, if the residual ridge 51 is not cut properly, too much force may be exerted, so that at the last moment, the maxillary sinus membrane 52 may be poked by means of the excessive force to result in rupture of the membrane 52. Therefore, the shape of the insert tip 34 is at least round, or preferably a disc type in order for an operator to have a feeling of slight dropping in the maxillary sinus 50 when all of the last part of the residual ridge 51 the end part of which is being ground is ground away. Accordingly, it is avoided to poke inadvertently the maxillary sinus membrane 52.

After forming a hole 53 and an opening 54 without damaging the maxillary sinus membrane 52, a graft material is then inserted in the hole 53 with the piezo packer 40. As shown in FIG. 6e, the interior border of the maxillary sinus membrane around the opening 54 is first lined with PRP collected from relevant patient's blood or a primary soft graft material 55 to buffer excessive pressure exerted on the maxillary sinus membrane 52 while pushing a secondary graft material 56 in a full scale. As shown in FIG. 6f, after lining the border with the primary graft material 55, the diameter of the hole 53 may be made wider with a piezo insert 30 to be more than 2.2 mm in its diameter for expanding the hole 53 in order to make the second graft material 56 enter the hole 53 smoothly.

Subsequently, as shown in FIG. 6a, the secondary graft material 56 is pushed up to a portion under the maxillary sinus membrane 52 above the opening 54 with the piezo packer 40 and then is fully rammed into the lower part of the maxillary sinus membrane 52. In this process, the particles of the secondary graft material 56 receive the vibration from the piezo packer 40 to relax the membrane 52 safely in order to move the second graft material 56 upwards and also to the lateral area well. As such, the cases that the graft material is directed only upward, not well to the lateral side or the hole 53 and the opening 54 are blocked, as in the prior art, can be avoided. FIG. 6h illustrates a state that the graft materials 55 and 56 are placed on the interior border of the maxillary sinus membrane 52 above the opening 54 through the hole 53 of the residual ridge 51, by means of the aforementioned process. FIG. 6i illustrates a state that the secondary graft material 56 is well positioned as sufficiently as an implant can be fixed. FIG. 6j illustrates a state that an implant 57 is fixed.

FIGS. 7a and 7b illustrate x-ray photography around a maxillary sinus before and after implant placement with a piezo insert 30 and a piezo packer 40 according to the invention through the operation process as described above. If bone grafting in a maxillary sinus is applied with a piezo insert 30 and a piezo packer 40 according to the invention, it is possible to finish bone grafting in a maxillary sinus quickly with minimum cut in a portion where an original tooth was located, and a relevant patient feels very comfortable after the operation according to the invention as compared to prior art operation.

It should be noted that the embodiment of the piezo insert and the piezo packer according to the invention as described above is intended to illustrate an example of the invention. Those skilled in the art will understand that various modifications and other equivalent embodiments thereof can be contemplated. Therefore, it should be understand that the invention is not limited to the specific embodiments as described above. Therefore, the true technical scope of the invention should be defined by the technical spirit specified in the accompanying claims. It should be understood that the invention is intended to cover all modifications, equivalents and substitutes thereof within the spirit and scope of the invention as defined in the accompanying claims.

With the piezo insert and the piezo packer as described above, it is easy to form and expand a hole in a vertical direction in a residual ridge when bone grafting is applied in a maxillary sinus with a piezoelectric device. In particular, if the residual ridge is not cut properly, excessive force may be applied to poke a maxillary sinus membrane with the force at the last moment to result in boring the membrane. The insert tip according to the invention is shaped at least round or preferably a disc type. Because of such a structure, when the residual ridge is fully ground at the last remaining portion of the residual ridge, an operator can feel slight dropping in the maxillary sinus, so that unintentional poking of the maxillary sinus membrane can be avoided. Also, in the process of pushing a graft material in a hole of the residual ridge, the particles of the graft material receive vibration from the piezo packer thus to relax the membrane safely. Therefore, the graft material goes upward and also spreads well to the lateral side. As such, the cases the graft material is directed only upward, and does not spread well to the lateral side, or the hole and the opening are blocked, as in the prior art, can be avoided.

The invention resides in each and every novel characteristic feature and each and every combination of features. Reference numerals in the claims do not limit the protective scope of these claims. The use of the verb “to comprise” and its conjugations does not exclude the presence of elements other than those stated in the claim. The use of the article “a” or “an” preceding an element does not exclude the presence of a plurality of such elements.

What is claimed is:

1. A piezo insert for implant surgical operation with a piezoelectric device, comprising:
a piezo insert body, one end of which is inserted in and fixed to a hand piece of the piezoelectric main device;
an insert pole extending from the other end of the piezo insert body; and
an insert tip formed at the end of the insert pole, the insert tip having a plurality of holes at its end in order to enhance vertical cutting force.

2. The piezo insert as claimed in claim 1, wherein the insert tip further comprises a plurality of holes formed at its end and on its lateral side to achieve both of vertical cutting force and lateral cutting force.

3. The piezo insert as claimed in claim 2, wherein the insert pole has a linear structure.

4. The piezo insert as claimed in claim 2, wherein the insert pole has a structure bent at least once.

5. The piezo insert as claimed in claim 1, wherein the insert pole has a linear structure.

6. The piezo insert as claimed in claim 1, wherein the insert pole has a structure bent at least once.

7. A piezo packer for implant surgical operation with a piezoelectric device, comprising:
a piezo packer body, one end of which is inserted in and fixed to a hand piece of the piezoelectric main device;
a packer pole extending from the other end of the piezo packer body; and
a packer tip formed at the end of the packer pole, the packer tip having a plurality of projections at its end in order to enhance bone removal and vibration transfer efficiency transferred to a graft material.

8. The piezo packer as claimed in claim 7, wherein the insert pole has a linear structure.

9. The piezo packer as claimed in claim 7, wherein the insert pole has a structure bent at least once.
